(19) United States
(12) Patent Application Publication
(10) Pub. No.: US 2023/0217055 A1
(43) Pub. Date: Jul. 6, 2023

(54) CHANNEL CONTENT CREATION SYSTEM

(71) Applicant: DENTSU INC., Tokyo (JP)

(72) Inventor: Toru ITO, Tokyo (JP)

(73) Assignee: DENTSU INC., Tokyo (JP)

(21) Appl. No.: 18/000,617

(22) PCT Filed: Jun. 10, 2021
(86) PCT No.: PCT/JP2021/022026

§ 371 Date: Dec. 2, 2022

(30) Foreign Application Priority Data
Jun. 12, 2020 (JP) 2020-102220

(51) Int. Cl. H04N 21/266; H04N 21/262

(52) U.S. Cl. CPC H04N 21/266; H04N 21/26241

(57) ABSTRACT

A channel content creation system capable of readily creating channel content is provided. A channel content creation system 1 selects program contents permitted to be published on a channel of a channel director from a plurality of program contents, extracts program contents satisfying a program search condition input by the channel director from the selected program contents, and displays the extracted program contents as candidates of program content to be selected when the channel director creates channel content. In addition, the channel content creation system 1 selects advertisement contents permitted to be published on the channel of the channel director from a plurality of advertisement contents, extracts advertisement contents satisfying an advertisement search condition input by the channel director from the selected advertisement contents, and displays the extracted advertisement contents as candidates of advertisement content to be selected when the channel director creates channel content.

### TECHNICAL FIELD

The present invention relates to a channel content creation system which creates channel content by arranging program contents and advertisement contents in a time series in a time table.

### BACKGROUND ART

Conventionally, content delivery systems which deliver images and video contents together with advertisements have been proposed. In a conventional content delivery system, advertisement viewing history from advertisement-containing content is analyzed, a distribution of an advertisement rate from an advertiser (distribution to a user terminal having viewed the advertisement and to a terminal of a content provider) is calculated based on the analysis result, and the advertisement rate is distributed to each terminal (for example, refer to Patent Literature 1).

### CITATION LIST

### Patent Literature

Patent Literature 1: Japanese Patent Laid-Open No. 2018-50271

### SUMMARY OF INVENTION

### Technical Problem

However, conventionally, there have been no proposals whatsoever with respect to methods of creating channel content. Although channel content can be created by arranging program contents and advertisement contents in a time series in a time table, so far, there have been no proposals with respect to simplifying the creation of channel content.

The present invention has been made in consideration of the problem described above and an object thereof is to provide a channel content creation system capable of readily creating channel content.

### Solution to Problem

A channel content creation system according to the present invention includes: a program server which stores a plurality of program contents created by a program content creator; an advertisement server which stores a plurality of advertisement contents created by an advertisement content creator; and a channel server operated by a channel director to create channel content by arranging the program contents and the advertisement contents in a time series in a time table of the channel director's own channel, wherein the program server includes a program information storage unit which stores program publishing availability information indicating, for each program content, whether or not publishing the program content on a channel of the channel director is to be permitted, the advertisement server includes an advertisement information storage unit which stores advertisement publishing availability information indicating, for each advertisement content, whether or not publishing the advertisement content on a channel of the channel director is to be permitted, and the channel server includes: a program content acquiring unit which selects and acquires, based on the program publishing availability information, program contents permitted to be published on a channel of the channel director from the plurality of program contents stored in the program server; a program content extracting unit which extracts program contents satisfying a program search condition input by the channel director from the program contents acquired by the program content acquiring unit; a program content candidate display unit which performs processing for displaying program contents extracted by the program content extracting unit as candidates of program content to be selected when the channel director creates the channel content; an advertisement content acquiring unit which selects and acquires, based on the advertisement publishing availability information, advertisement contents permitted to be published on a channel of the channel director from the plurality of advertisement contents stored in the advertisement server; an advertisement content extracting unit which extracts advertisement contents satisfying an advertisement search condition input by the channel director from the advertisement contents acquired by the advertisement content acquiring unit; and an advertisement content candidate display unit which performs processing for displaying advertisement contents extracted by the advertisement content extracting unit as candidates of advertisement content to be selected when the channel director creates the channel content.

According to this configuration, program contents permitted to be published on a channel of a channel director are selected from a plurality of program contents stored in a program server, and program contents satisfying a program search condition input by the channel director are extracted from the selected program contents and displayed as candidates of program content to be selected when the channel director creates channel content. In addition, advertisement contents permitted to be published on a channel of the channel director are selected from a plurality of advertisement contents stored in an advertisement server, and advertisement contents satisfying an advertisement search condition input by the channel director are extracted from the selected advertisement contents and displayed as candidates of advertisement content to be selected when the channel director creates channel content.

Program contents and advertisement contents that are not permitted to be published on the channel of the channel director have been removed (subjected to filter processing) from program contents and advertisement contents displayed as candidates. Therefore, the channel director can create channel content using only program contents and advertisement contents permitted to be published on the channel director's own channel by arranging program contents and advertisement contents being displayed as candidates in a time series in a time table. Accordingly, since the channel director need no longer check for program contents and advertisement contents that are not permitted to be published on the channel director's own channel after creating channel content (check whether the created channel content does not include program contents and advertisement contents not permitted to be published on the channel director's own channel), channel content can be readily created.

In addition, in the channel content creation system according to the present invention, the program information storage unit of the program server may store, with respect to each program content, noncompatible advertisement information indicating advertisement contents that do not satisfy a compatibility condition with the program content, and the channel server may include an advertisement prohibition processing unit which, when arranging advertisement contents selected from the advertisement contents displayed as candidates of the advertisement content in a time table of the channel, performs processing of prohibiting advertisement contents not satisfying the compatibility condition with the program content from being arranged in proximity to the program content in the time table of the channel based on the noncompatible advertisement information.

According to this configuration, when arranging advertisement contents selected from advertisement contents displayed as candidates of the advertisement content in a time table of the channel, advertisement contents not satisfying the compatibility condition with program content are prohibited from being arranged in proximity to the program content in the time table of the channel. Accordingly, since the channel director need no longer check for advertisement contents not satisfying the compatibility condition with program content after creating channel content (check whether advertisement contents not satisfying the compatibility condition with the program content are not arranged in proximity to the program content in the time table of the channel), channel content can be readily created.

In addition, in the channel content creation system according to the present invention, the advertisement information storage unit of the advertisement server may store, with respect to each advertisement content, noncompatible program information indicating program contents that do not satisfy a compatibility condition with the advertisement content, and the channel server may include a program prohibition processing unit which, when arranging program contents selected from the program contents displayed as candidates of the program content in a time table of the channel, performs processing of prohibiting program contents not satisfying the compatibility condition with the advertisement content from being arranged in proximity to the advertisement content in the time table of the channel based on the noncompatible program information.

According to this configuration, when arranging program contents selected from program contents displayed as candidates of the program content in a time table of the channel, program contents not satisfying the compatibility condition with advertisement content are prohibited from being arranged in proximity to the advertisement content in the time table of the channel. Accordingly, since the channel director need no longer check for program contents not satisfying the compatibility condition with advertisement content after creating channel content (check whether program contents not satisfying the compatibility condition with the advertisement content are not arranged in proximity to the advertisement content in the time table of the channel), channel content can be readily created.

Furthermore, the channel content creation system according to the present invention may include an investigation server which investigates a viewing state of the program contents and a viewing state of the advertisement contents when the channel content is delivered to a viewer, wherein the program server includes a program viewing information acquiring unit which acquires program viewing information indicating a viewing state of the program contents from the investigation server and causes the program information storage unit to store the program viewing information, the advertisement server includes an advertisement viewing information acquiring unit which acquires advertisement viewing information indicating a viewing state of the advertisement contents from the investigation server and causes the advertisement information storage unit to store the advertisement viewing information, and in the channel server, the program search condition used in the program content extracting unit may include the program viewing information and the advertisement search condition used in the advertisement content extracting unit may include the advertisement viewing information.

According to this configuration, when the channel content is delivered to a viewer, the investigation server investigates a viewing state of the program contents and a viewing state of the advertisement contents. Program viewing information indicating a viewing state of program contents is stored in the program information storage unit of the program server and can be used as a program search condition when extracting program contents in the channel server. In addition, advertisement viewing information indicating a viewing state of advertisement contents is stored in the advertisement information storage unit of the advertisement server and can be used as an advertisement search condition when extracting advertisement contents in the channel server. Accordingly, channel content that takes viewing states of program contents and advertisement contents into consideration can be readily created.

In addition, in the channel content creation system according to the present invention, the channel server includes a time table editing unit which edits the time table by rearranging the program contents and the advertisement contents on the time table.

According to this configuration, the channel director can readily edit the time table by rearranging the program contents and the advertisement contents on the time table.

A channel server according to the present invention is a channel server operated by a channel director to create channel content by arranging the program contents and the advertisement contents in a time series in a time table of the channel director's own channel, wherein a program server stores a plurality of program contents created by a program content creator and stores program publishing availability information indicating, for each program content, whether or not publishing the program content on a channel of the channel director is to be permitted, an advertisement server stores a plurality of advertisement contents created by an advertisement content creator and stores advertisement publishing availability information indicating, for each advertisement content, whether or not publishing the advertisement content on a channel of the channel director is to be permitted, and the channel server includes: a program content acquiring unit which selects and acquires, based on the program publishing availability information, program contents permitted to be published on a channel of the channel director from the plurality of program contents stored in the program server; a program content extracting unit which extracts program contents satisfying a program search condition input by the channel director from the program contents acquired by the program content acquiring unit; a program content candidate display unit which performs processing for displaying program contents extracted by the program content extracting unit as candidates of program content to be selected when the channel director creates the channel content; an advertisement content acquiring unit which selects and acquires, based on the advertisement publishing availability information, advertisement contents permitted to be published on a channel of the channel director from the plurality of advertisement contents stored in the advertisement server; an advertisement content extracting unit which extracts advertisement contents satisfying an advertisement search condition input by the channel director from the advertisement contents acquired by the advertisement content acquiring unit; and an advertisement content candidate display unit which performs processing for displaying advertisement contents extracted by the advertisement content extracting unit as candidates of advertisement content to be selected when the channel director creates the channel content.

Even with the channel server, in a similar manner to the system described above, since the channel director need no longer check for program contents and advertisement contents that are not permitted to be published on the channel director's own channel after creating channel content (check whether the created channel content does not include program contents and advertisement contents not permitted to be published on the channel director's own channel), channel content can be readily created.

A program according to the present invention is a program executed by a channel server operated by a channel director to create channel content by arranging the program contents and the advertisement contents in a time series in a time table of the channel director's own channel, wherein a program server stores a plurality of program contents created by a program content creator and stores program publishing availability information indicating, for each program content, whether or not publishing the program content on a channel of the channel director is to be permitted, an advertisement server stores a plurality of advertisement contents created by an advertisement content creator and stores advertisement publishing availability information indicating, for each advertisement content, whether or not publishing the advertisement content on a channel of the channel director is to be permitted, and the program causes the channel server to execute processing for: selecting and acquiring, based on the program publishing availability information, program contents permitted to be published on a channel of the channel director from the plurality of program contents stored in the program server; extracting program contents satisfying a program search condition input by the channel director from the program contents acquired by the program content acquiring unit; displaying program contents extracted by the program content extracting unit as candidates of program content to be selected when the channel director creates the channel content; selecting and acquiring, based on the advertisement publishing availability information, advertisement contents permitted to be published on a channel of the channel director from the plurality of advertisement contents stored in the advertisement server; extracting advertisement contents satisfying an advertisement search condition input by the channel director from the advertisement contents acquired by the advertisement content acquiring unit; and displaying advertisement contents extracted by the advertisement content extracting unit as candidates of advertisement content to be selected when the channel director creates the channel content.

Even with the program, in a similar manner to the system described above, since the channel director need no longer check for program contents and advertisement contents that are not permitted to be published on the channel director's own channel after creating channel content (check whether the created channel content does not include program contents and advertisement contents not permitted to be published on the channel director's own channel), channel content can be readily created.

### Advantageous Effect of Invention

According to the present invention, channel content can be readily created.

### BRIEF DESCRIPTION OF DRAWINGS

FIG. 1 is a block diagram showing a configuration of a channel content creation system according to an embodiment of the present invention.

FIG. 2 is a diagram showing an example of a database structure of a program database.

FIG. 3 is a diagram showing an example of a database structure of an advertisement database.

FIG. 4 is a diagram showing an example of a screen display when creating channel content.

FIG. 5 is a flow chart for describing an operation of creating channel content according to the embodiment of the present invention.

### DESCRIPTION OF EMBODIMENT

Hereinafter, a channel content creation system according to an embodiment of the present invention will be described with reference to the drawings. In the present embodiment, a case of a channel content creation system used in a platform of a video delivery service (a video delivery platform) or the like will be exemplified.

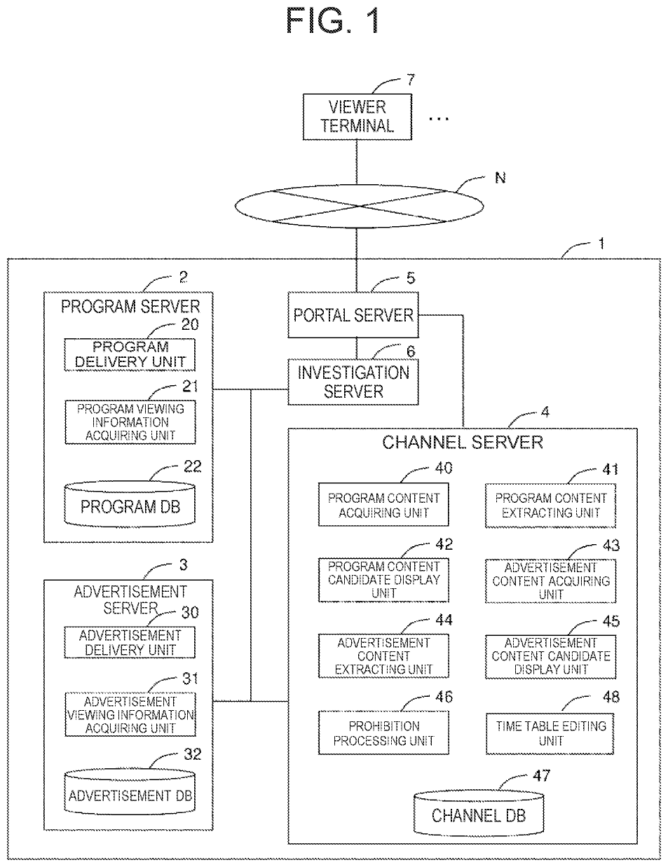

A configuration of the channel content creation system according to the present embodiment will be described with reference to the drawings. FIG. 1 is a block diagram showing a configuration of the channel content creation system according to the present embodiment. As shown in FIG. 1, a channel content creation system 1 includes a program server 2, an advertisement server 3, a channel server 4, a portal server 5, and an investigation server 6. The portal server 5 is connected to a plurality of viewer terminals 7 via a network N.

The program server 2 is a server to be operated by a program content creator. The program server 2 includes a program delivery unit 20, a program viewing information acquiring unit 21, and a program database (DB) 22. The program database 22 stores a plurality of program contents created by the program content creator. The program delivery unit 20 includes a function of delivering, by streaming, program contents stored in the program database 22 to the viewer terminal 7. The program viewing information acquiring unit 21 acquires program viewing information indicating a viewing state of program contents from the investigation server 6. The program viewing information acquired by the program viewing information acquiring unit 21 is stored in the program database 22. In addition, the program database 22 stores program publishing availability information indicating, with respect to each program content, whether or not to permit publishing on a channel of the channel director. Furthermore, the program database 22 stores, with respect to each program content, noncompatible advertisement information that indicates advertisement contents that do not satisfy a compatibility condition with the program content.

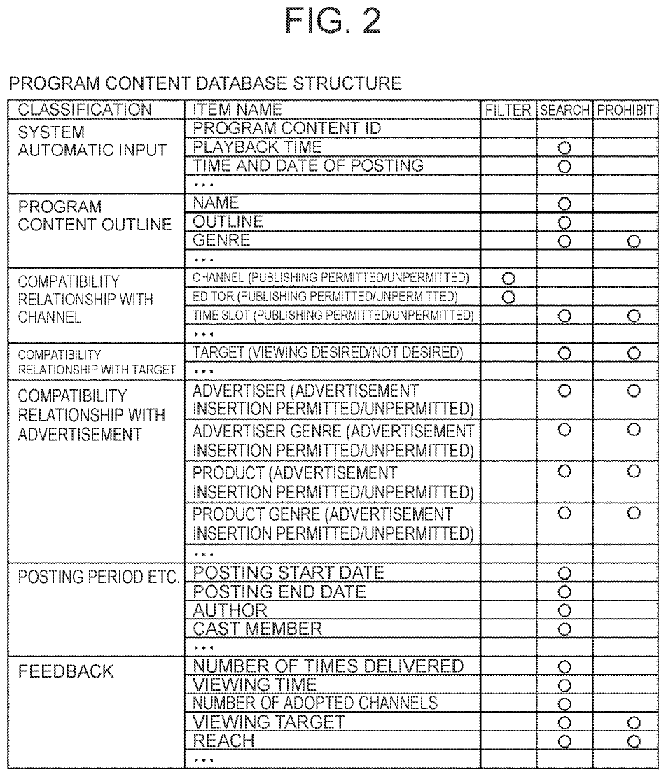

FIG. 2 is a diagram showing an example of a database structure of the program database 22. As shown in FIG. 2, the program database 22 has data of a plurality of “items” with respect to each stored program content. Data of each “item” is divided into a larger “classification”. In other words, one “classification” includes a plurality of “items”. For example, a classification of “system automatic input” includes items of “program content ID”, “playback time”, “time and date of posting”, and the like. In addition, for each “item”, whether or not program content is to be an object of filter processing, search processing, and prohibition processing to be described later is set. In the example shown in FIG. 2, processing which program content is to be subjected to is circled.

For example, an item called “channel (publishing permitted/unpermitted)” records data on a channel which permits publishing/a channel which does not permit publishing, and filter processing of program contents (to be described later) is to be performed based on the data of “channel (publishing permitted/unpermitted)”. In addition, an item called “advertiser (advertisement insertion permitted/unpermitted)” records data on an advertiser who permits advertisement insertion/an advertiser who does not permit advertisement insertion, and search processing of program contents (to be described later) can be performed based on the data of “advertiser (advertisement insertion permitted/unpermitted)”. Furthermore, prohibition processing of advertisement contents (to be described later) is to be also performed based on the data of “advertiser (advertisement insertion permitted/unpermitted)”.

The advertisement server 3 is a server to be operated by an advertisement content creator. The advertisement server 3 includes an advertisement delivery unit 30, an advertisement viewing information acquiring unit 31, and an advertisement database (DB) 32. The advertisement database 32 stores a plurality of advertisement contents created by the advertisement content creator. The advertisement delivery unit 30 includes a function of delivering, by streaming, advertisement contents stored in the advertisement database 32 to the viewer terminal 7. The advertisement viewing information acquiring unit 31 acquires advertisement viewing information indicating a viewing state of advertisement contents from the investigation server 6. The advertisement viewing information acquired by the advertisement viewing information acquiring unit 31 is stored in the advertisement database 32. In addition, the advertisement database 32 stores advertisement publishing availability information indicating, with respect to each advertisement content, whether or not to permit publishing on a channel of the channel director. Furthermore, the advertisement database 32 stores, with respect to each advertisement content, noncompatible program information that indicates program contents that do not satisfy a compatibility condition with the advertisement content.

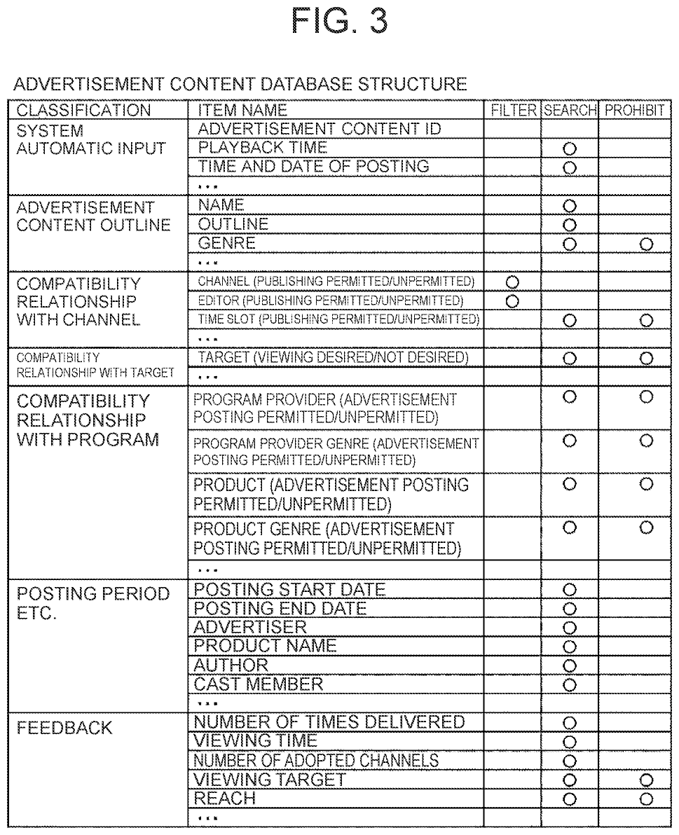

FIG. 3 is a diagram showing an example of a database structure of the advertisement database 32. As shown in FIG. 3, the advertisement database 32 has data of a plurality of “items” with respect to each stored advertisement content. Data of each “item” is divided into a larger “classification”. In other words, one “classification” includes a plurality of “items”. For example, a classification of “system automatic input” includes items of “advertisement content ID”, “playback time”, “time and date of posting”, and the like. In addition, for each “item”, whether or not advertisement content is to be an object of filter processing, search processing, and prohibition processing to be described later is set. In the example shown in FIG. 3, processing which advertisement content is to be subjected to is circled.

For example, an item called “channel (publishing permitted/unpermitted)” records data on a channel which permits publishing/a channel which does not permit publishing, and filter processing of advertisement contents (to be described later) is to be performed based on the data of “channel (publishing permitted/unpermitted)”. In addition, an item called “program provider (advertisement posting permitted/unpermitted)” records data on a program provider who permits advertisement posting/a program provider who does not permit advertisement posting, and search processing of advertisement contents (to be described later) can be performed based on the data of “program provider (advertisement posting permitted/unpermitted)”. Furthermore, prohibition processing of program contents (to be described later) is to be also performed based on the data of “program provider (advertisement insertion permitted/unpermitted)”.

The channel server 4 is a server to be operated by a channel director. The channel server 4 includes a program content acquiring unit 40, a program content extracting unit 41, a program content candidate display unit 42, an advertisement content acquiring unit 43, an advertisement content extracting unit 44, an advertisement content candidate display unit 45, a prohibition processing unit 46, and a channel database (DB) 47. In addition, the channel server 4 includes a time table editing unit 48 which edits a time table by rearranging program contents and advertisement contents on the time table. Each function of the channel server 4 can be realized by a program stored in a hard disk (HD), a memory, or the like of the channel server 4.

The program content acquiring unit 40 selects and acquires, based on program publishing availability information, program contents of which publishing on a channel of the channel director is permitted from the plurality of program contents stored in the program server 2. More specifically, based on data of “channel (publishing permitted/unpermitted)” in the program database 22, program contents of which publishing on the channel of the channel director are permitted are selected and acquired from the plurality of program contents stored in the program database 22. In this manner, filter processing of program contents is performed.

The program content extracting unit 41 extracts program contents satisfying a program search condition input by the channel director from the program contents acquired by the program content acquiring unit 40 (program contents subjected to filter processing), and the program content candidate display unit 42 displays the program contents extracted by the program content extracting unit 41 as candidates of program content to be selected when the channel director creates channel content. In this manner, search processing of program contents is performed. The program search condition used by the program content extracting unit 41 also includes program viewing information acquired from the investigation server 6.

The advertisement content acquiring unit 43 selects and acquires, based on advertisement publishing availability information, advertisement contents of which publishing on a channel of the channel director is permitted from the plurality of advertisement contents stored in the advertisement server 3. More specifically, based on data of “channel (publishing permitted/unpermitted)” in the advertisement database 32, advertisement contents of which publishing on the channel of the channel director are permitted are selected and acquired from the plurality of advertisement contents stored in the advertisement server 3. In this manner, filter processing of advertisement contents is performed.

The advertisement content extracting unit 44 extracts advertisement contents satisfying an advertisement search condition input by the channel director from the advertisement contents acquired by the advertisement content acquiring unit 43 (advertisement contents subjected to filter processing), and the advertisement content candidate display unit 45 displays the advertisement contents extracted by the advertisement content extracting unit 44 as candidates of advertisement content to be selected when the channel director creates channel content. In this manner, search processing of advertisement contents is performed. The advertisement search condition used by the advertisement content extracting unit 44 also includes advertisement viewing information acquired from the investigation server 6.

When arranging program contents selected from program contents displayed as candidates of the program content in a time table of the channel, the prohibition processing unit 46 performs processing of prohibiting program contents not satisfying a compatibility condition with advertisement content from being arranged in proximity to the advertisement content in the time table of the channel based on the noncompatible program information.

In addition, when arranging advertisement contents selected from advertisement contents displayed as candidates of the advertisement content in a time table of the channel, the prohibition processing unit 46 performs processing of prohibiting advertisement contents not satisfying a compatibility condition with program content from being arranged in proximity to the program content in the time table of the channel based on the noncompatible advertisement information.

The channel database 47 temporarily stores data of program contents, advertisement contents, and the like when the channel director creates channel content. Screen display when the channel director creates channel content is generated based on data stored in the channel database 47.

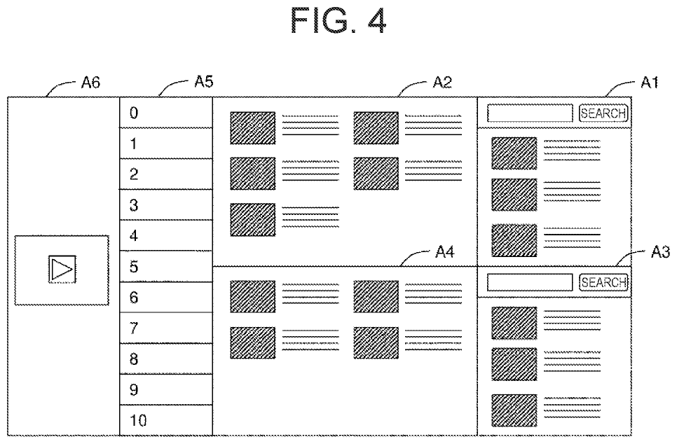

FIG. 4 is a diagram showing an example of a screen display when the channel director creates channel content. As shown in FIG. 4, an operation screen of the channel director is divided into, for example, a program search area A1, a program pool area A2, an advertisement search area A3, an advertisement pool area A4, a time table area A5, and a preview area A6.

The program search area A1 is an area used by the channel director to search for program contents. A box for inputting a program search condition and a search button are displayed in the program search area A1 and, by inputting a program search condition to the box and clicking the search button, program contents found as a result of search processing are displayed. In the example shown in FIG. 4, three program contents found as a result of search processing are displayed.

The program pool area A2 is an area used by the channel director to pool program contents. By dragging and dropping program contents displayed in the program search area A1, the channel director can temporarily pool program contents of interest. In the example shown in FIG. 4, five program contents are pooled.

The advertisement search area A3 is an area used by the channel director to search for advertisement contents. A box for inputting an advertisement search condition and a search button are displayed in the advertisement search area A3 and, by inputting an advertisement search condition to the box and clicking the search button, advertisement contents found as a result of search processing are displayed. In the example shown in FIG. 4, three advertisement contents found as a result of search processing are displayed.

The advertisement pool area A4 is an area used by the channel director to pool advertisement contents. By dragging and dropping advertisement contents displayed in the advertisement search area A3, the channel director can temporarily pool advertisement contents of interest. In the example shown in FIG. 4, four advertisement contents are pooled.

The time table area A5 is an area used by the channel director to arrange program contents and advertisement contents in a time series in a time table of the channel director's own channel and to edit the time table. A function of editing the time table is realized by the time table editing unit 48. By dragging and dropping program contents pooled in the program pool area A2 and advertisement contents pooled in the advertisement pool area A4, program contents and advertisement contents can be arranged in a time series in any time slot (at any location) on the time table. Program contents and advertisement contents may be arranged in a time series in a designated time slot (at a designated location) on the time table. In addition, the channel director can shuffle the program contents and advertisement contents when necessary. In this manner, channel content is created by arranging program contents and advertisement contents on the time table. In the example shown in FIG. 4, a time table from twelve midnight to 10 o'clock (in FIG. 4, program contents and advertisement contents are not yet arranged) is displayed.

The preview area A6 is an area used by the channel director to preview created channel content. By clicking an icon representing the channel content, playback and pause of the created channel content can be performed.

The portal server 5 is a server to be operated by a channel portal operator. The portal server 5 includes a function of displaying a plurality of channel contents in the form of a list to viewers. The investigation server 6 is a server to be operated by a viewing state investigator. The investigation server 6 includes a function of investigating, when channel content is delivered to a viewer, a viewing state of program contents and a viewing state of advertisement contents. Functions of the portal server 5 and the investigation server 6 can be realized by known techniques.

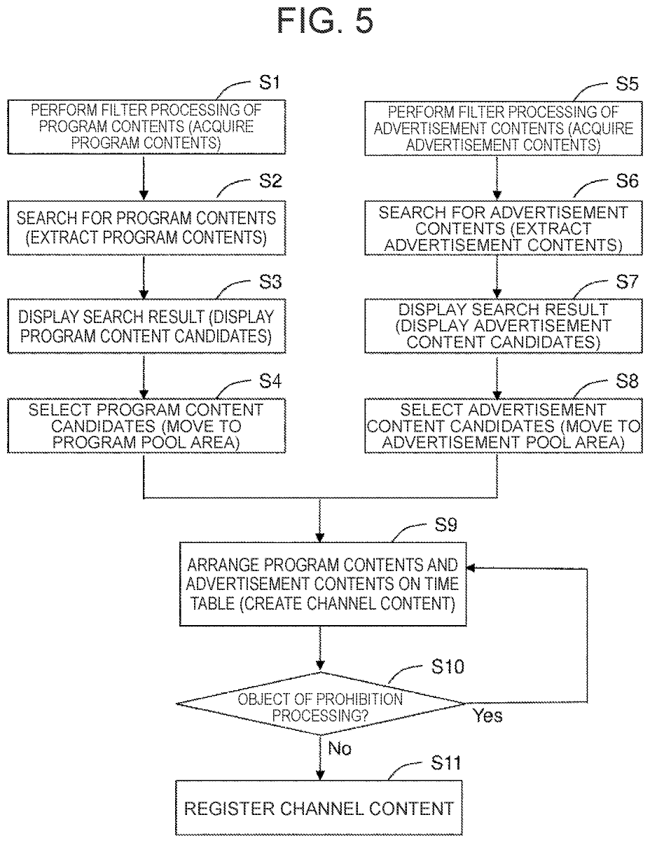

Operations of the channel content creation system 1 configured as described above will be described with reference to a flow shown in FIG. 5.

As shown in FIG. 5, in the channel content creation system 1 according to the present embodiment, when the channel director creates channel content, filter processing of program contents is first performed in the channel server 4. Specifically, based on program publishing availability information in the program database 22, program contents of which publishing on a channel of the channel director is permitted are selected and acquired from the plurality of program contents stored in the program server 2 (S1).

Next, search processing of program contents is performed. Specifically, program contents satisfying a program search condition input by the channel director are extracted from the program contents acquired by the program content acquiring unit 40 (program contents subjected to filter processing) (S2), and the program contents are displayed in the program search area A1 as candidates of program content to be selected when the channel director creates channel content (S3). The channel director selects program content candidates of interest from the program content candidates displayed in the program search area A1 and moves the selected program content candidates to the program pool area A2 (S4).

In addition, filter processing of advertisement contents is performed in the channel server 4. Specifically, based on advertisement publishing availability information in the advertisement database 32, advertisement contents of which publishing on the channel of the channel director is permitted are selected and acquired from the plurality of advertisement contents stored in the advertisement server 3 (S5).

Next, search processing of advertisement contents is performed. Specifically, advertisement contents satisfying an advertisement search condition input by the channel director are extracted from the advertisement contents acquired by the advertisement content acquiring unit 43 (advertisement contents subjected to filter processing) (S6), and the advertisement contents are displayed in the advertisement search area A3 as candidates of advertisement content to be selected when the channel director creates channel content (S7). The channel director selects advertisement content candidates of interest from the advertisement content candidates displayed in the advertisement search area A3 and moves the selected advertisement content candidates to the advertisement pool area A4 (S8).

In addition, the channel director creates channel content by arranging program contents and advertisement contents in a time series in a time table (S9). At this point, prohibition processing of the program contents and the advertisement contents is performed (S10).

Specifically, when arranging program contents selected from program contents displayed as candidates of the program content in the time table of the channel, program contents not satisfying a compatibility condition with advertisement content are prohibited from being arranged in proximity to the advertisement content in the time table of the channel based on the noncompatible program information. In addition, when arranging advertisement contents selected from advertisement contents displayed as candidates of the advertisement content in the time table of the channel, advertisement contents not satisfying a compatibility condition with program content are prohibited from being arranged in proximity to the program content in the time table of the channel based on the noncompatible advertisement information.

The channel content created as described above is registered in the channel database 47 (S11). In addition, the channel content is delivered from the portal server 5 to the viewer terminal 7. When the channel content is delivered to the viewer terminal 7, program contents are delivered by streaming from the program server 2 and advertisement contents are delivered by streaming from the advertisement server 3. In addition, a viewing state of the program contents and a viewing state of the advertisement contents are respectively investigated by the investigation server 6.

With the channel content creation system 1 according to the present embodiment described above, program contents permitted to be published on a channel of a channel director are selected from a plurality of program contents stored in the program server 2, and program contents satisfying a program search condition input by the channel director are extracted from the selected program contents and displayed as candidates of program content to be selected when the channel director creates channel content. In addition, advertisement contents permitted to be published on the channel of the channel director are selected from a plurality of advertisement contents stored in the advertisement server 3, and advertisement contents satisfying an advertisement search condition input by the channel director are extracted from the selected advertisement contents and displayed as candidates of advertisement content to be selected when the channel director creates channel content.

Program contents and advertisement contents that are not permitted to be published on the channel of the channel director have been removed (subjected to filter processing) from program contents and advertisement contents displayed as candidates. Therefore, the channel director can create channel content using only program contents and advertisement contents permitted to be published on the channel director's own channel by arranging program contents and advertisement contents being displayed as candidates in a time series in a time table. Accordingly, since the channel director need no longer check for program contents and advertisement contents that are not permitted to be published on the channel director's own channel after creating channel content (check whether the created channel content does not include program contents and advertisement contents not permitted to be published on the channel director's own channel), channel content can be readily created.

In addition, in the present embodiment, when arranging advertisement contents selected from advertisement contents displayed as candidates of advertisement content in a time table of the channel, advertisement contents not satisfying the compatibility condition with program content are prohibited from being arranged in proximity to the program content in the time table of the channel. Accordingly, since the channel director need no longer check for advertisement contents not satisfying the compatibility condition with program content after creating channel content (check whether advertisement contents not satisfying the compatibility condition with the program content are not arranged in proximity to the program content in the time table of the channel), channel content can be readily created.

In addition, in the present embodiment, when arranging program contents selected from program contents displayed as candidates of program content in a time table of the channel, program contents not satisfying the compatibility condition with advertisement content are prohibited from being arranged in proximity to the advertisement content in the time table of the channel. Accordingly, since the channel director need no longer check for program contents not satisfying the compatibility condition with advertisement content after creating channel content (check whether program contents not satisfying the compatibility condition with the advertisement content are not arranged in proximity to the advertisement content in the time table of the channel), channel content can be readily created.

In addition, in the present embodiment, when the channel content is delivered to a viewer, the investigation server 6 investigates a viewing state of the program contents and a viewing state of the advertisement contents. Program viewing information indicating a viewing state of program contents is stored in the program database 22 of the program server 2 and can be used as a program search condition when extracting program contents in the channel server 4. In addition, advertisement viewing information indicating a viewing state of advertisement contents is stored in the advertisement database 32 of the advertisement server 3 and can be used as an advertisement search condition when extracting advertisement contents in the channel server 4. Accordingly, channel content that takes viewing states of program contents and advertisement contents into consideration can be readily created.

In addition, in the present embodiment, since the channel server 4 includes the time table editing unit 48, the channel director can readily edit the time table by rearranging the program contents and the advertisement contents on the time table.

While an embodiment of the present invention has been described by way of example, the scope of the present invention is not limited to the embodiment and that the invention can be changed or modified depending on the intended use within the scope of claims.

For example, in the channel server 4, program contents and advertisement contents need not necessarily be displayed. For example, channel content may be automatically created by arranging program contents and advertisement contents extracted by the program content extracting unit 41 and the advertisement content extracting unit 44 in a time table according to a predetermined rule (for example, in chronological order of creation dates). In such a case, screen display such as that shown in FIG. 4 is also no longer necessary.

### INDUSTRIAL APPLICABILITY

As described above, the channel content creation system according to the present invention produces an advantageous effect of enabling channel content to be readily created and is usefully applied to a video delivery platform and the like.

### REFERENCE SIGNS LIST

1 Channel content creation system
2 Program server
3 Advertisement server
4 Channel server
5 Portal server
6 Investigation server
7 Viewer terminal
20 Program delivery unit
21 Program viewing information acquiring unit
22 Program database (program information storage unit)
30 Advertisement delivery unit
31 Advertisement viewing information acquiring unit
32 Advertisement database (advertisement information storage unit)
40 Program content acquiring unit
41 Program content extracting unit
42 Program content candidate display unit
43 Advertisement content acquiring unit
44 Advertisement content extracting unit
45 Advertisement content candidate display unit
46 Prohibition processing unit
47 Channel database
48 Time table editing unit
N Network
A1 Program search area
A2 Program pool area
A3 Advertisement search area
A4 Advertisement pool area
A5 Time table area
A6 Preview area

1. A channel content creation system, comprising:
a program server which stores a plurality of program contents created by a program content creator;
an advertisement server which stores a plurality of advertisement contents created by an advertisement content creator; and
a channel server operated by a channel director to create channel content by arranging the program contents and the advertisement contents in a time series in a time table of the channel director's own channel, wherein
the program server includes
a program information storage unit which stores program publishing availability information indicating, for each program content, whether or not publishing the program content on a channel of the channel director is to be permitted,
the advertisement server includes
an advertisement information storage unit which stores advertisement publishing availability information indicating, for each advertisement content, whether or not publishing the advertisement content on a channel of the channel director is to be permitted, and
the channel server includes:
a program content acquiring unit which selects and acquires, based on the program publishing availability information, program contents permitted to be published on a channel of the channel director from the plurality of program contents stored in the program server;
a program content extracting unit which extracts program contents satisfying a program search condition input by the channel director from the program contents acquired by the program content acquiring unit;
a program content candidate display unit which performs processing for displaying program contents extracted by the program content extracting unit as candidates of program content to be selected when the channel director creates the channel content;
an advertisement content acquiring unit which selects and acquires, based on the advertisement publishing availability information, advertisement contents permitted to be published on a channel of the channel director from the plurality of advertisement contents stored in the advertisement server;
an advertisement content extracting unit which extracts advertisement contents satisfying an advertisement search condition input by the channel director from the advertisement contents acquired by the advertisement content acquiring unit; and
an advertisement content candidate display unit which performs processing for displaying advertisement contents extracted by the advertisement content extracting unit as candidates of advertisement content to be selected when the channel director creates the channel content.

2. The channel content creation system according to claim 1, wherein
the program information storage unit of the program server
stores, with respect to each program content, noncompatible advertisement information indicating advertisement contents that do not satisfy a compatibility condition with the program content, and
the channel server includes
an advertisement prohibition processing unit which, when arranging advertisement contents selected from the advertisement contents displayed as candidates of the advertisement content in a time table of the channel, performs processing of prohibiting advertisement contents not satisfying the compatibility condition with the program content from being arranged in proximity to the program content in the time table of the channel based on the noncompatible advertisement information.

3. The channel content creation system according to claim 1, wherein
the advertisement information storage unit of the advertisement server stores, with respect to each advertisement content, noncompatible program information indicating program contents that do not satisfy a compatibility condition with the advertisement content, and
the channel server includes
a program prohibition processing unit which, when arranging program contents selected from the program contents displayed as candidates of the program content in a time table of the channel, performs processing of prohibiting program contents not satisfying the compatibility condition with the advertisement content from being arranged in proximity to the advertisement content in the time table of the channel based on the noncompatible program information.

4. The channel content creation system according to claim 1, comprising
an investigation server which investigates a viewing state of the program contents and a viewing state of the advertisement contents when the channel content is delivered to a viewer, wherein
the program server includes
a program viewing information acquiring unit which acquires program viewing information indicating a viewing state of the program contents from the investigation server and causes the program information storage unit to store the program viewing information,
the advertisement server includes
an advertisement viewing information acquiring unit which acquires advertisement viewing information indicating a viewing state of the advertisement contents from the investigation server and causes the advertisement information storage unit to store the advertisement viewing information, and
in the channel server,
the program search condition used in the program content extracting unit includes the program viewing information and the advertisement search condition used in the advertisement content extracting unit includes the advertisement viewing information.

5. The channel content creation system according to claim 1, wherein the channel server includes a time table editing unit which edits the time table by rearranging the program contents and the advertisement contents on the time table.

6. A channel server operated by a channel director to create channel content by arranging program contents and advertisement contents in a time series in a time table of the channel director's own channel, wherein
a program server stores a plurality of program contents created by a program content creator and stores program publishing availability information indicating, for each program content, whether or not publishing the program content on a channel of the channel director is to be permitted,
an advertisement server stores a plurality of advertisement contents created by an advertisement content creator and stores advertisement publishing availability information indicating, for each advertisement content, whether or not publishing the advertisement content on a channel of the channel director is to be permitted, and
the channel server comprises:
a program content acquiring unit which selects and acquires, based on the program publishing availability information, program contents permitted to be published on a channel of the channel director from the plurality of program contents stored in the program server;
a program content extracting unit which extracts program contents satisfying a program search condition input by the channel director from the program contents acquired by the program content acquiring unit;
a program content candidate display unit which performs processing for displaying program contents extracted by the program content extracting unit as candidates of program content to be selected when the channel director creates the channel content;
an advertisement content acquiring unit which selects and acquires, based on the advertisement publishing availability information, advertisement contents permitted to be published on a channel of the channel director from the plurality of advertisement contents stored in the advertisement server;
an advertisement content extracting unit which extracts advertisement contents satisfying an advertisement search condition input by the channel director from the advertisement contents acquired by the advertisement content acquiring unit; and
an advertisement content candidate display unit which performs processing for displaying advertisement contents extracted by the advertisement content extracting unit as candidates of advertisement content to be selected when the channel director creates the channel content.

7. A program executed by a channel server operated by a channel director to create channel content by arranging program contents and advertisement contents in a time series in a time table of the channel director's own channel, wherein
a program server stores a plurality of program contents created by a program content creator and stores program publishing availability information indicating, for each program content, whether or not publishing the program content on a channel of the channel director is to be permitted,
an advertisement server stores a plurality of advertisement contents created by an advertisement content creator and stores advertisement publishing availability information indicating, for each advertisement content, whether or not publishing the advertisement content on a channel of the channel director is to be permitted, and
the program causes the channel server to execute processing for:
selecting and acquiring, based on the program publishing availability information, program contents permitted to be published on a channel of the channel director from the plurality of program contents stored in the program server;
extracting program contents satisfying a program search condition input by the channel director from the program contents acquired;
displaying program contents extracted as candidates of program content to be selected when the channel director creates the channel content;
selecting and acquiring, based on the advertisement publishing availability information, advertisement contents permitted to be published on a channel of the channel director from the plurality of advertisement contents stored in the advertisement server;
extracting advertisement contents satisfying an advertisement search condition input by the channel director from the advertisement contents acquired; and
displaying advertisement contents extracted as candidates of advertisement content to be selected when the channel director creates the channel content.
